(19) United States
(12) Patent Application Publication
(10) Pub. No.: US 2004/0240909 A1
(43) Pub. Date: Dec. 2, 2004

(54) Developing device and process cartridge including the same for use in electro photographic image-forming apparatus

(75) Inventors: Masanari Morioka, Tokyo (JP); Yoshiyuki Batori, Tokyo (JP); Hiroki Ogino, Tokyo (JP)

Correspondence Address: Canon U.S.A. Inc., Intellectual Property Department, 15975 Alton Parkway, Irvine, CA, 92618-3731, US

(73) Assignee: Canon Kabushiki Kaisha, Tokyo (JP)

(21) Appl. No.: 10/845,817

(22) Filed: May 14, 2004

(30) Foreign Application Priority Data
May 30, 2003 (JP) 2003-154073

(51) Int. Cl. G03G 15/08

(52) U.S. Cl. 399/279

(57) ABSTRACT

A developing device for developing an electrostatic latent image formed on an electrophotographic photoreceptor includes a hollow developing roller, a support member inserted in the hollow developing roller to support the developing roller, a flange member having a first engaging portion engaging with an outer surface of the support member and a second engaging portion engaging with an inner surface of the developing roller, and a gap-holding member disposed at one end of the developing roller, the gap-holding member having an abutment abutting against the electrophotographic photoreceptor for maintaining a gap between the developing roller and the electrophotographic photoreceptor. The abutment overlaps with the second engaging portion in the longitudinal direction of the developing roller.

### BACKGROUND OF THE INVENTION

1. Field of the Invention

The present invention relates to a developing device and a process cartridge for use in an electrophotographic image-forming system.

2. Description of the Related Art

Known is a process cartridge system in which an electrophotographic photoreceptor and a developing device are integrated in a cartridge, and the cartridge is demountable from a main body of an electrophotographic image forming apparatus. With this process cartridge system, an operator can maintain the apparatus without depending on a service engineer. Thus, this process cartridge system has been widely employed in image forming apparatuses.

The above-mentioned process cartridge system includes a developing device for developing a latent image formed on an electrophotographic photoreceptor with a developer. Such a developing device has a stationary magnet disposed in a cylindrical developing roller. By rotating the developing roller, the developer is fed to a photosensitive drum (the photoreceptor).

The support mechanism of the developing roller will be described with reference to FIGS. 11 and 12. The electrophotographic photoreceptor (not shown) is rotatably supported by the frame of the cartridge. As shown in FIG. 11, a developing roller 10d has gap-holding members 10m rotatably disposed at both ends thereof, for maintaining a predetermined gap between the electrophotographic photoreceptor and the developing roller 10d.

The developing roller 10d has developing-roller flanges 10d1 disposed at both ends thereof. Each developing-roller flange 10d1 is held by a bearing member 10w.

Also, the developing roller 10d has a stationary magnet 10c disposed inside thereof. The stationary magnet 10c is held by stationary-magnet holding members 10c1.

The bearing members 10w and the stationary-magnet holding members 10c1 are positioned by corresponding positioning members 10f5 disposed in a toner-developing frame 10f1. With this structure, a relative position between the developing roller 10d and the stationary magnet 10c is determined.

### SUMMARY OF THE INVENTION

The present invention is directed to a developing device, a process cartridge incorporating the developing device, and an image forming apparatus incorporating the process cartridge demountable therein.

The process cartridge of the present invention maintains a uniform gap between a developing roller and an electrophotographic photoreceptor and minimizes deformation of the developing roller.

In one aspect of the present invention, the developing device includes a hollow developing roller, a support member inserted in the hollow developing roller to support the developing roller, a flange member having a first engaging portion engaging with an outer surface of the support member and a second engaging portion engaging with an inner surface of the developing roller, and a gap-holding member disposed at one end of the developing roller, having an abutment abutting against the electrophotographic photoreceptor for maintaining a gap between the developing roller and the electrophotographic photoreceptor. In one embodiment, the abutment overlaps with the second engaging portion in the longitudinal direction of the developing roller.

In another embodiment, the abutment overlaps with the first and second engaging portions in the longitudinal direction of the developing roller.

Further features and advantages of the present invention will become apparent from the following description of the preferred embodiments with reference to the attached drawings.

### BRIEF DESCRIPTION OF THE DRAWINGS

FIG. 1 is a schematic view of an image forming apparatus incorporating a process cartridge according to one embodiment of the present invention.

FIG. 2 is a schematic view of the process cartridge shown in FIG. 1.

FIG. 3 is an exploded perspective view of a developing device of the process cartridge shown in FIG. 1.

FIG. 4 is an enlarged perspective view of a supporting structure of a developing roller.

FIGS. 5A and 5B are perspective views of a developing-roller flange.

FIGS. 6A and 6B are schematic views of the developing-roller flange and an electrode.

FIG. 7 is a schematic view illustrating a fixing structure of the developing-roller flange and a developing roller.

FIG. 8 is a sectional view illustrating the supporting structure of the developing roller.

FIG. 9 is a sectional view illustrating assembly of the developing roller.

FIG. 10 is another sectional view illustrating the supporting structure of the developing roller.

FIG. 11 is a perspective view illustrating the supporting structure of a known developing roller.

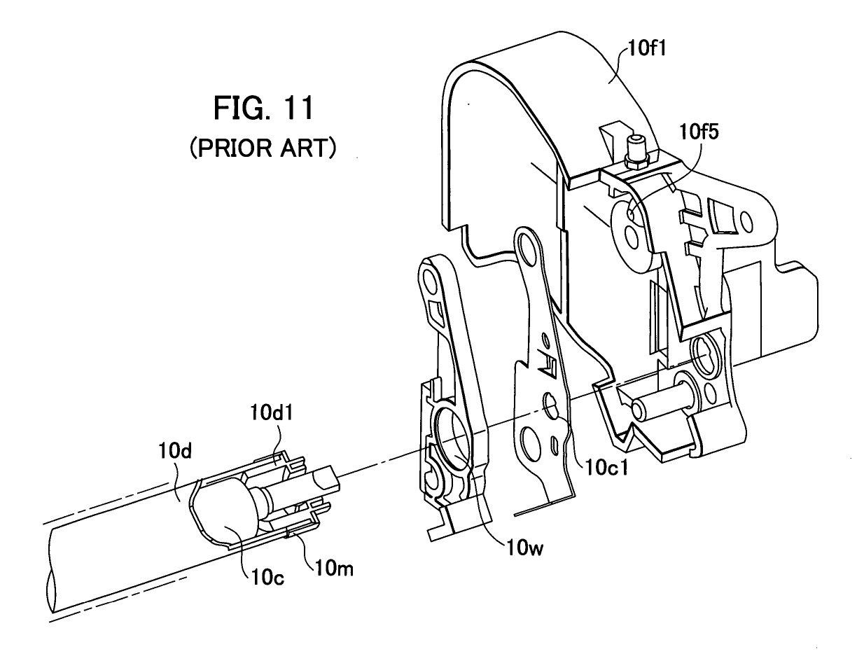

FIG. 12 is a sectional view illustrating the supporting structure of the known developing roller shown in FIG. 10.

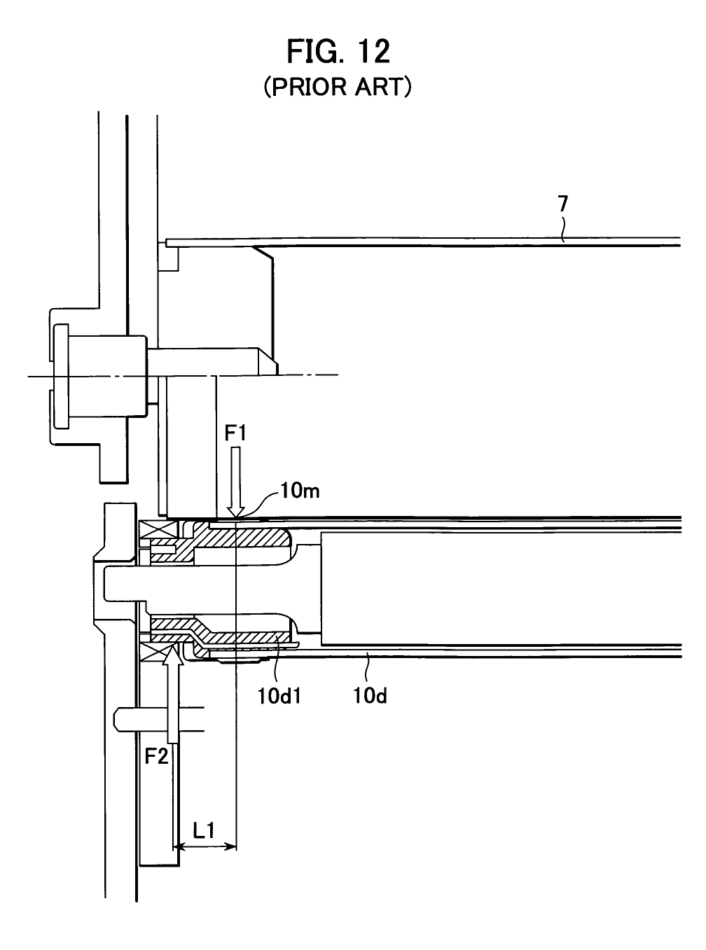

### DESCRIPTION OF THE PREFERRED EMBODIMENTS

A developing device, a process cartridge, and an electrophotographic image forming apparatus according to one embodiment of the present invention will be described with reference to the attached drawings.

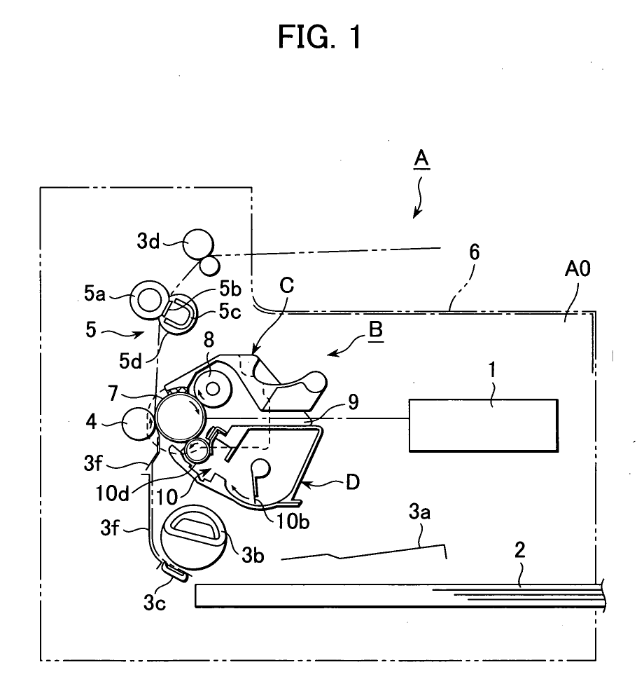

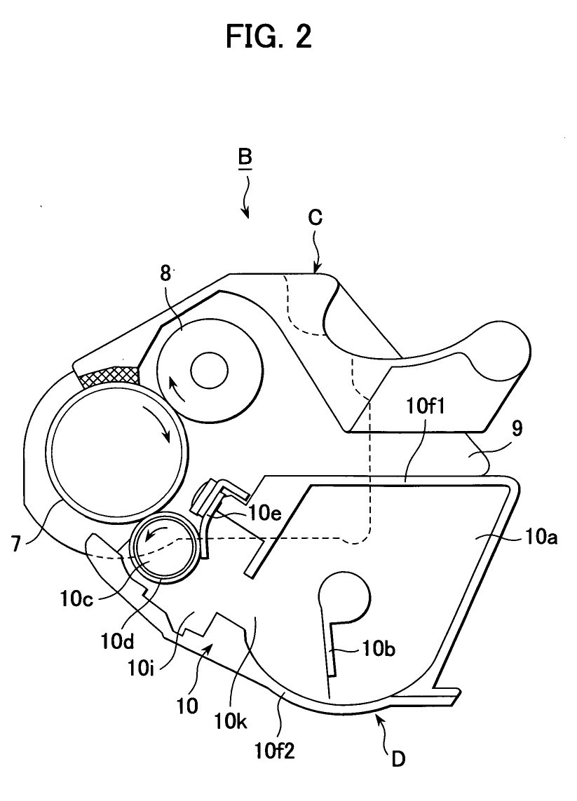

FIG. 1 is a schematic view of an electrophotographic image forming apparatus A (hereinafter, sometimes simply referred to as an image forming apparatus) incorporating a process cartridge B mounted therein in accordance with one embodiment of the present invention. FIG. 2 is a schematic view of the process cartridge B shown in FIG. 1. The process cartridge B is demountable from the main body of the electrophotographic image forming apparatus A.

The process cartridge B including a developing device and the electrophotographic image forming apparatus A incorporating the process cartridge B mounted therein will be described with reference to FIGS. 1 and 2.

Image Forming Apparatus

As shown in FIG. 1, the electrophotographic image forming apparatus A includes the process cartridge B. The process cartridge B has a photosensitive drum 7 serving as an electrophotographic photoreceptor. The photosensitive drum 7, which can be composed of an aluminum alloy, has an outer photosensitive layer serving as an organic photo conductive layer.

An optical system 1 emits information-encoded light including image information onto the photosensitive drum 7 so as to form a latent image on the photosensitive drum 7. When the latent image is developed with a developer (hereinafter, referred to as toner), a toner image is formed on the photosensitive drum 7.

In synchronization with formation of the toner image, recording media 2 are separated from a feed cassette 3a. A pickup roller 3b and a pressure member 3c pressing against the pickup roller 3b feed the separated recording media 2 sheet by sheet. A transporting means 3f then transports each recording medium 2.

The toner image formed on the photosensitive drum 7 is transferred onto the recording medium 2 by applying a voltage on a transfer roller 4 serving as transferring means. Then, the recording medium 2 is transported to fixing means 5 by the transporting means 3f.

The fixing means 5 has a drive roller 5a, a heater 5b, and a fixing rotor 5d. The fixing rotor 5d includes a cylindrical sheet rotatably supported by a support member 5c. The fixing means 5 applies heat and pressure onto the recording medium 2 passing therethrough. The toner image transferred as described above is fixed onto the recording medium 2. Then, the recording medium 2 is transported by a pair of discharge rollers 3d, which discharges the recording medium 2 onto a discharge section 6.

Process Cartridge Including Developing Device

The process cartridge B according to one embodiment of the present invention includes the electrophotographic photoreceptor 7 and at least developing means 10.

As shown in FIGS. 1 and 2, the process cartridge Bincludes the photosensitive drum 7, an electrostatic charging roller 8, and the developing means 10. By rotating the photosensitive drum 7 and applying a voltage on the electrostatic charging roller 8 serving as charging means, the surface of the photosensitive drum 7 is uniformly charged. Then, an optical image from the optical system 1 is exposed onto the charged photosensitive drum 7 through an exposure opening 9. Thus, a latent image is formed on the photosensitive drum 7. The latent image formed on the photosensitive drum 7 is developed by the developing means 10.

In the present embodiment, the developing means 10 includes a toner-developing frame 10f1 and a lid member 10f2. While toner (monocomponent magnetic developer) in a toner chamber (toner storage) 10a is sent to a developing chamber 10i by a rotatable toner-transporting roller 10b after passing through an opening 10k, a developing roller 10d having a magnet 10c built therein is rotated. In addition, a developing blade 10e forms a toner layer containing frictional electrostatic charges on the surface of the developing roller 10d. Then, the toner is transferred onto the photosensitive drum 7 in accordance with the latent image. With this arrangement, the toner image is formed on the photosensitive drum 7. In other words, the latent image is developed and visualized.

Then, by applying a voltage having a reverse polarity to that of the toner image on the transfer roller 4, the toner image is transferred onto the recording medium 2. Subsequently, the photosensitive drum 7 is charged by the electrostatic charging roller 8 and is then exposed. Thus, an electrostatic latent image is formed on the photosensitive drum 7. When the electrostatic latent image is developed, the toner remaining on the photosensitive drum 7 is collected with a fog-removing bias voltage (i.e., a fog-removing potential Vback, which is a difference in a direct voltage applied on the developing device and a potential on the surface of the photoreceptor) onto the developing roller 10d. In the present embodiment, a cleaning blade for cleaning the toner remaining on the photosensitive drum 7 is not provided.

The process cartridge B is detachably mounted on cartridge-mounting means provided in the main body A0 of the apparatus A.

Also, the process cartridge B is formed by assembling a drum frame unit C and a developing unit D together.

Supporting Mechanism of Developing Roller

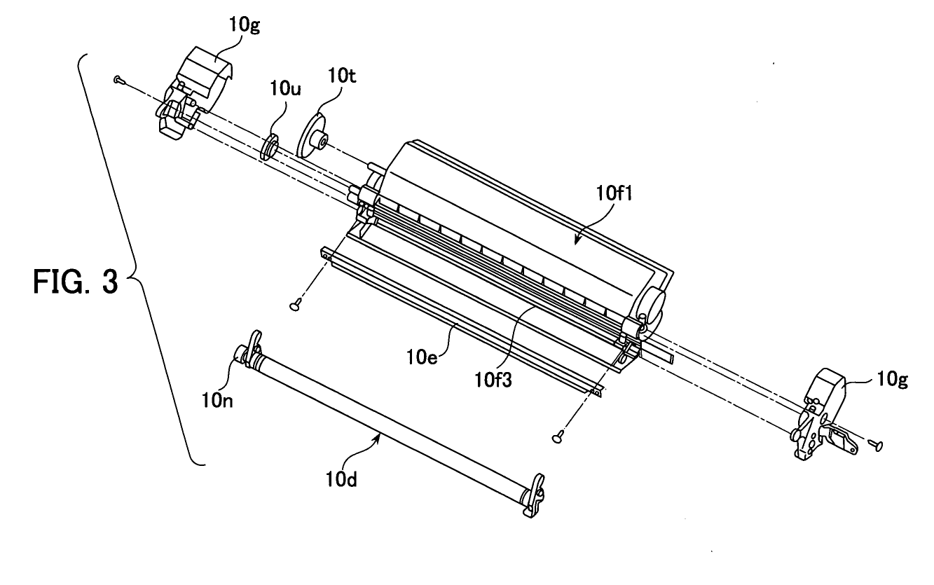

FIG. 3 is an exploded perspective view of the developing device. The toner-developing frame 10f1 supports the developing roller 10d rotatably fixed in an opening 10f3 thereof and supports the developing blade 10e fixed in the same with a screw.

Both ends of the developing roller 10d are rotatably supported by end members 10g fixed to the toner-developing frame 10f1. A drive force is transmitted to a developing-roller gear 10n fixed to one end of the developing roller 10d via a gear train formed by idler gears 10t and 10u so as to rotate the developing roller 10d.

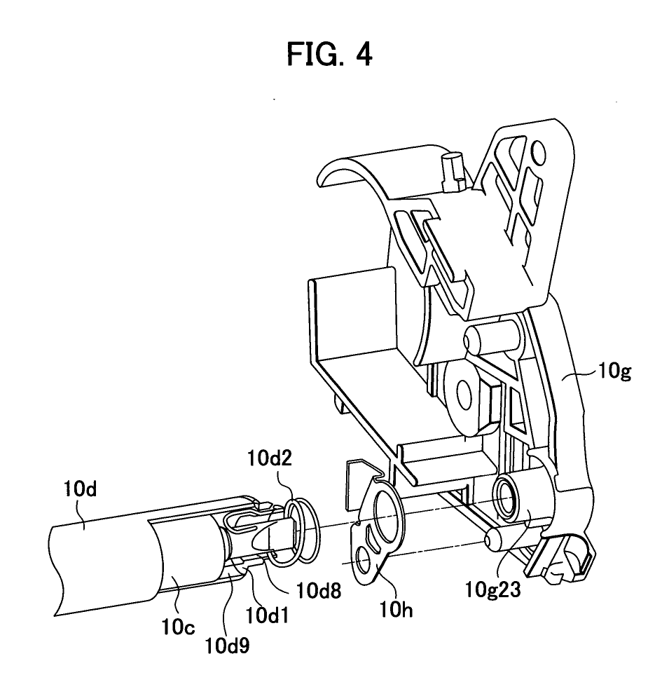

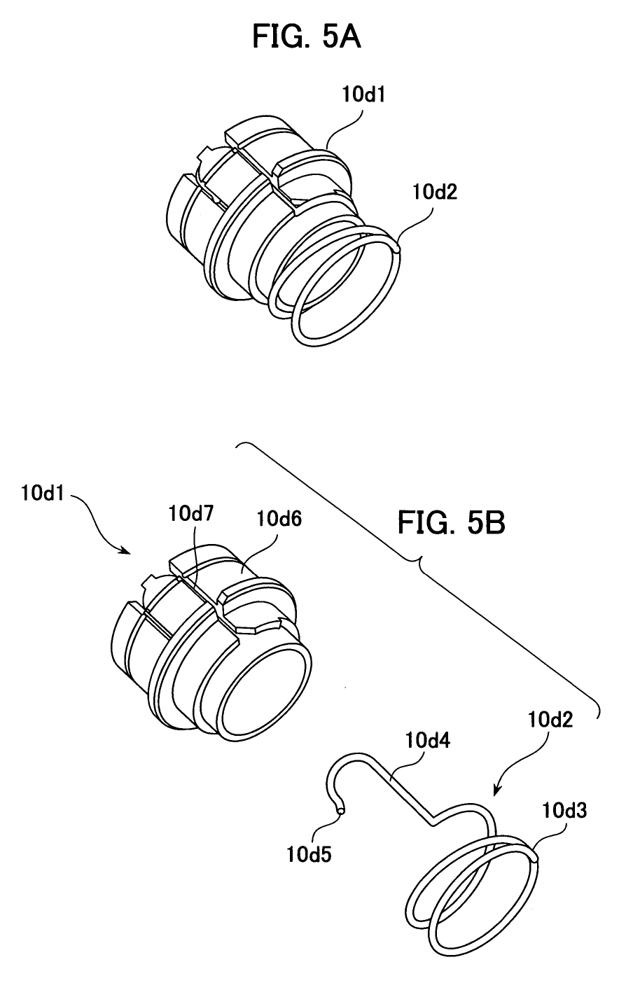

FIG. 4 is a perspective view of the support structure of the developing roller 10d. FIGS. 5A-B are perspective views of a developing flange 10d1 of the developing roller 10d. The developing roller 10d has a cylindrical developing-roller flange 10d1 fixed to each end thereof. The developing-roller flange 10d1 can be a resin-molded product. As shown in FIGS. 5A-B, the developing-roller flange 10d1 has a press-fit portion 10d6 and a groove 10d7 formed therein. The press-fit portion 10d6 is press fitted in the end of the developing roller 10d so as to be firmly fixed to the end. The groove 10d7 is used for fixing a connecting portion 10d4 of an electrode 10d2 thereto.

The electrode 10d2 includes first and second contacts 10d3 and 10d5 and the connecting portion 10d4. The first contact 10d3 is electrically connected to a frame-side electrode 10h (see FIG. 4) fixed to the corresponding end member 10g, and the second contact 10d5 is electrically connected to the developing roller 10d. When an electrode (not shown) of the main body and the frame-side electrode 10h are connected to each other, a developing bias voltage is supplied to the developing roller 10d via the electrode 10d2.

As shown in FIGS. 4 and 5A-B, the groove 10d7 extends longitudinally along the press-fit portion 10d6, and the press-fit portion 10d6 contacts with an inner circumferential surface 10d9 of the developing roller 10d when the developing-roller flange 10d1 is press-fitted into the developing roller 10d.

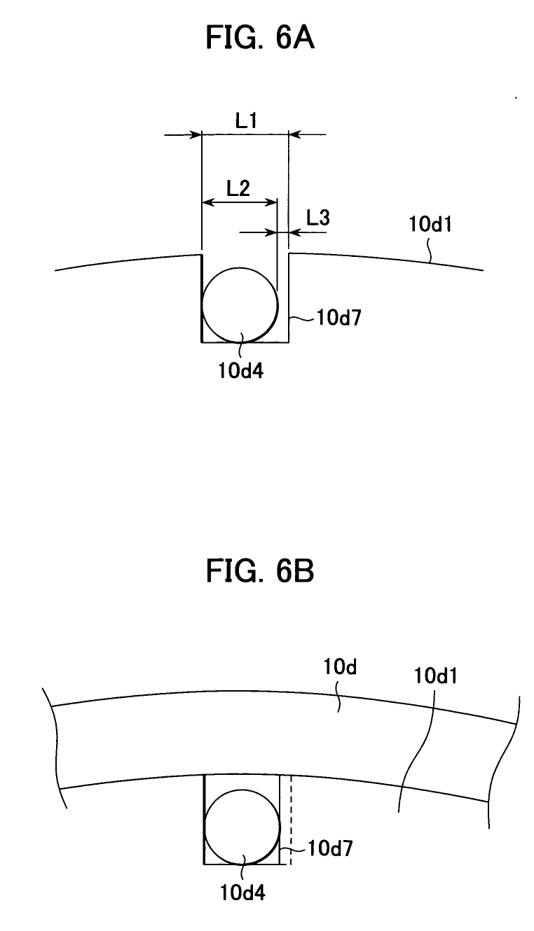

FIGS. 6A and 6B are schematic views of the developing-roller flange 10d1 and the connecting portion 10d4. FIG. 6A shows the developing-roller flange 10d1 in a state in which it is not press-fitted into the developing roller 10d. The width L1 of the groove 10d7 is greater than a diameter L2 of the connecting portion 10d4, and a gap L3 remains between the groove 10d7 and the connecting portion 10d4. In the present embodiment, the gap L3 can be about 0.01 mm to 0.0214 mm. FIG. 6B shows when the developing-roller flange 10d1 is press-fitted into the corresponding end of the developing roller 10d. As shown, the groove 10d7 is deformed such that the width L1 is substantially equal to the diameter L2 of the connecting portion 10d4, and such that the connecting portion 10d4 abuts against the groove 10d7.

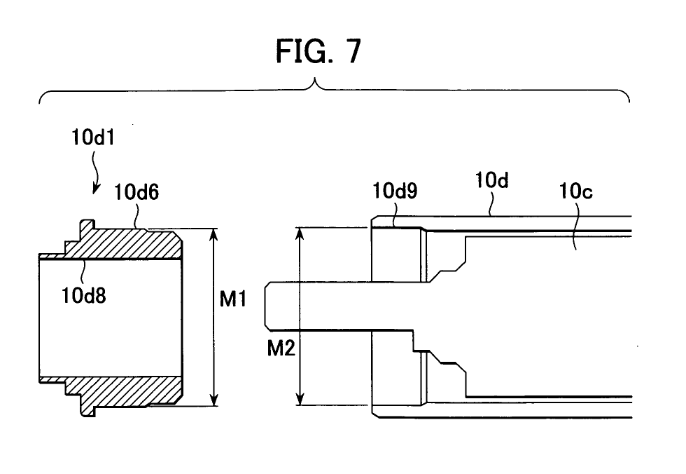

FIG. 7 is a schematic view illustrating a fixing structure of the developing-roller flange 10d1 and a developing roller 10d. A diameter M1 of the press-fit portion (outer circumference) 10d6 of the developing-roller flange 10d1 is configured larger than a diameter M2 of the inner circumferential surface (inner circumference) 10d9 of the corresponding end of the developing roller 10d when the flange 10d1 is not yet press fitted into the roller 10d. A difference between the diameters M1 and M2 serves as a press-fit interference M3.

In the present embodiment, when the developing-roller flange 10d1 is press-fitted into the corresponding end of the developing roller 10d, the resin-molded developing-roller flange 10d1 is deformed by the inner circumferential surface 10d9. Stress is concentrated in the groove 10d7, possibly deteriorating the round shape of the press-fit portion 10d6. Also, the roundness of the end of the developing roller 10d into which the corresponding developing-roller flange 10d1 is press-fitted may deteriorate, in addition to possibly deteriorating the roundness of an inner circumferential surface 10d8 of the developing-roller flange 10d1.

In order to minimize deterioration of the above-mentioned roundness, the gap L3 is set so as to be smaller than the press-fit interference M3. With this configuration, when the developing-roller flange 10d1 is press-fitted into the developing roller 10d, the connecting portion 10d4 always abuts against the groove 10d7, thereby minimizing deterioration of the roundness of the press-fit portion 10d6 of the developing-roller flange 10d1.

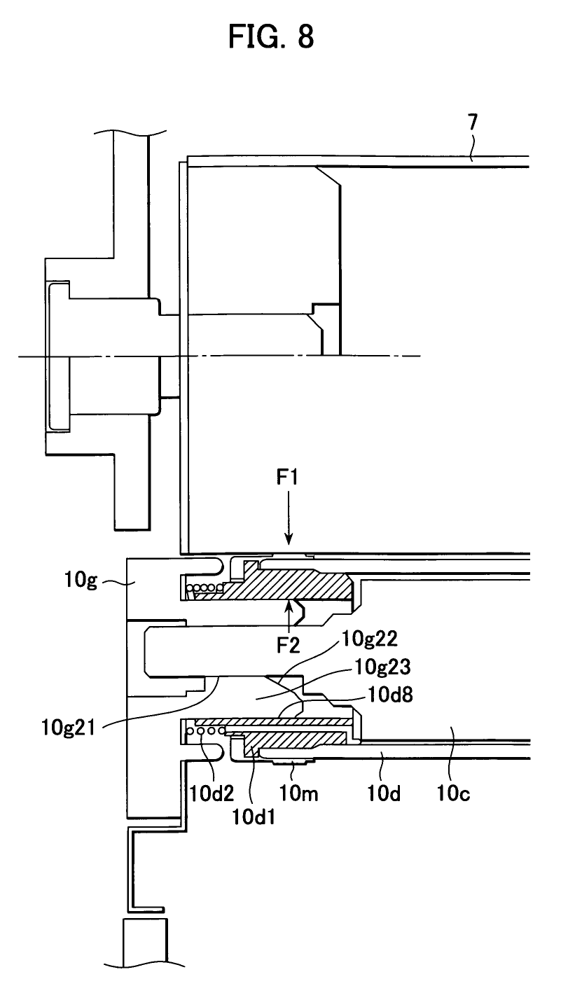

FIG. 8 is a sectional view illustrating the support structure of the developing roller 10d. As shown in FIGS. 4 and 8, in order to rotatably support the developing roller 10d having the flanges 10d1 fixed thereto, each end member 10g has a projection 10g23 protruding therefrom, serving as a developing-roller support member. When the projection 10g23 is inserted along the inner circumferential surface 10d8 of the flange 10d1, the outer circumference of the projection 10g23 rotatably supports the developing roller 10d.

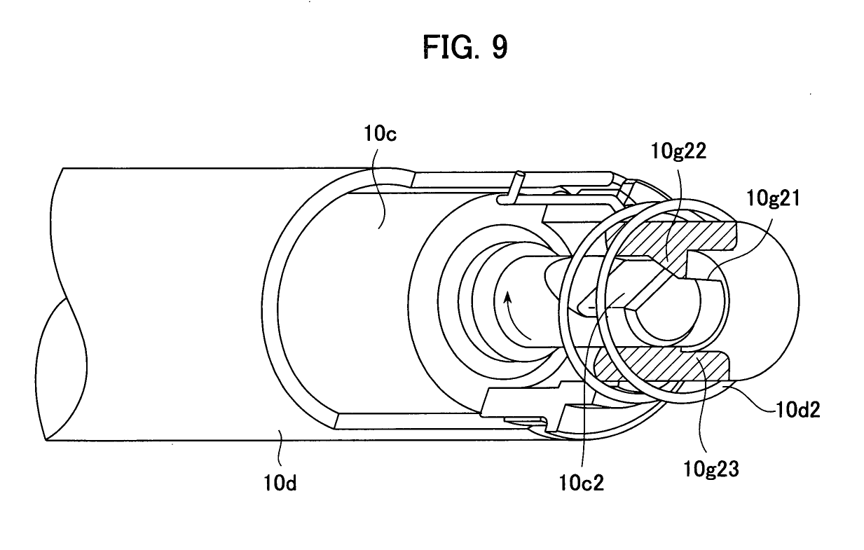

Each end member 10g has a guide 10g22 disposed therein, supporting and positioning the stationary magnet 10c disposed in the developing roller 10d. The shape of the guide 10g22 will be described with reference to FIG. 9. FIG. 9 is a sectional perspective view illustrating assembly of the developing roller 10d. FIG. 9 illustrates a D-cut phase-adjusting member 10c2 formed at one of the ends of the stationary magnet 10c and a D-cut phase-adjusting member 10g21 formed in the inner circumference of the projection 10g23. Also, FIG. 9 illustrates the phase-adjusting member 10c2 inserted out of phase with the projection 10g23.

The projection 10g23, with a hollow structure, has the guide 10g22 disposed in the inner circumference thereof. The guide 10g22 has a slope for guiding the phase-adjusting member 10c2 so as to be in concert with the phase-adjusting member 10g21.

As the stationary magnet 10c is further inserted from the position shown in FIG. 9, the geometric shape of the guide 10g22 facilitates rotation of the end of the stationary magnet 10c in a direction shown by the arrow indicated in FIG. 9, for example. As the stationary magnet 10c is still further inserted, the stationary magnet 10c engages with the phase-adjusting member of the end member 10g, thereby smoothly assembling the stationary magnet 10c into the end member 10g.

Referring to FIG. 8, the developing roller 10d has gap-holding members 10m provided at both ends thereof. With the gap-holding members 10m, the developing roller 10d and the photosensitive drum 7 are separated from each other by a fine gap therebetween. In the present embodiment, each gap-holding member 10m is a capped roller having a cap shape, fitted into and fixed to the corresponding end of the developing roller 10d. A part of the capped roller protrudes outward with a predetermined width and is pressed against the circumferential surface of the photosensitive drum 7.

With this structure, as shown in FIG. 8, the developing roller 10d receives a force F1 from the photosensitive drum 7 via the gap-holding members 10m, and the projections 10g23 of the end members 10g serving as support members of the developing roller 10d apply a reaction force F2 opposing the force F1. In this state, each projection 10g23 lies in the inner circumference of the corresponding developing-roller flange 10d1. Thus, the projection 10g23 supports the vicinity of a part (corresponding to the gap holding member 10m) pressed by the photosensitive drum 7, of the inner circumference of the corresponding flange 10d1. As such, a torque generated in the developing roller 10d is minimized as compared to the conventional case where the developing roller 10d is externally supported in the axial direction thereof.

Thus, deformation of the developing roller 10d is minimized, so that the gap between the photosensitive drum 7 and the developing roller 10d is more uniformly maintained. Further, since the projection 10g23 lies closer to the corresponding gap-holding member 10m in the axial direction of the developing roller 10d, the above advantage can be more effectively achieved. Accordingly, the gap-holding member 10m and the corresponding projection 10f23 should be configured to overlap completely with each other.

As previously described, the inner circumference of the projections 10g23 supports the stationary magnet 10c and determines the rotating direction and the center position of the stationary magnet 10c. That is, a single member positions two components (the stationary magnet 10c and the developing roller 10d) as described above. As a result, the relative position between these two components is achieved more accurately, thereby leading to a uniform magnetic-force distribution on the surface of the developing roller 10d.

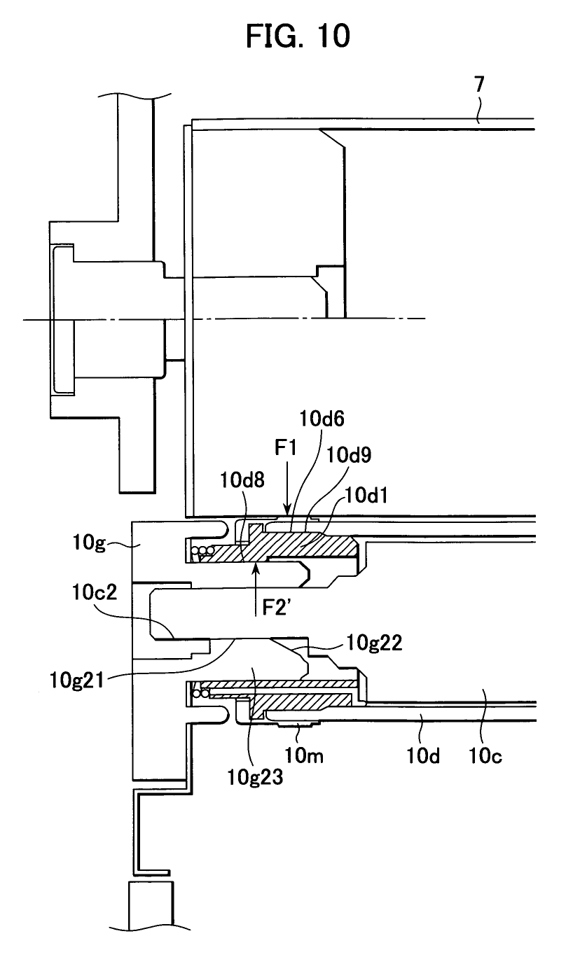

FIG. 10 is another sectional view illustrating the supporting structure of the developing roller 10d. The inner circumferential surface 10d8 of the flange 10d1 is deformed when the flange 10d1 is forcefully press-fitted into the corresponding end of the developing roller 10d. As such, the flange 10d1 is configured such that the press-fit portion 10d6, engaging with the inner circumferential surface 10d9 of the developing roller 10d, and the inner circumferential surface 10d8 of the flange 10d1, engaging with the outer circumference of the corresponding projection 10g23, are mutually displaced in the direction of the rotating axis of the developing roller 10d.

Since the developing roller 10d is press-fitted, a force exerted on the press-fit portion 10d6 does not affect the inner circumferential surface 10d8 of the developing-roller flange 10d1. As a result, deformation of the inner circumferential surface 10d8 is prevented, thereby preventing deformation of the developing roller 10d and accordingly reducing uneven toner density when performing toner development.

Even in such a state, each projection 10g23 is arranged so as to support the vicinity of a part pressed by the photosensitive drum 7, of the inner circumference of the flange 10d1 so that the force F1 from the photosensitive drum 7 and the reaction force F2 are exerted close to each other in the longitudinal direction of the developing roller.

Although the process cartridge according to the foregoing embodiment does not include cleaning means mounted thereon for cleaning the photoreceptor, the present invention is not limited to such a structure, and the present invention can be incorporated in a process cartridge having cleaning means mounted thereon.

As described above, according to the present invention, the gap between the electrophotographic receptor and the developing roller can be more uniformly kept.

While the present invention has been described with reference to the structures disclosed herein, it is not confined to the detailed set forth and this application is intended to cover such modifications or changes as may come within the purpose of the improvements or the scope of the following claims.

What is claimed is:

1. A developing device for developing an electrostatic latent image formed on an electrophotographic photoreceptor, comprising:
a hollow developing roller having an inner surface;
a support member inserted in the developing roller to support the developing roller, the support member having an outer surface;
a flange member having a first engaging portion engaging with the outer surface of the support member and a second engaging portion engaging with the inner surface of the developing roller; and
a gap-holding member disposed at one end of the developing roller, the gap-holding member having an abutment abutting against the electrophotographic photoreceptor so as to maintain a gap between the developing roller and the electrophotographic photoreceptor,
wherein the abutment overlaps with the second engaging portion in the longitudinal direction of the developing roller.

2. The developing device according to claim 1,
wherein the abutment overlaps with the first engaging portion in the longitudinal direction of the developing roller.

3. The developing device according to claim 1, wherein the abutment lies in the second engaging portion in the longitudinal direction of the developing roller.

4. The developing device according to claim 1, further comprising a magnet disposed within the developing roller,
wherein the support member comprises
a positioning portion positioning the magnet relative to the developing roller; and
a guide guiding the magnet to the positioning portion,
wherein the guide rotates the magnet as the magnet is being inserted into the support member.

5. The developing device according to claim 1, wherein the second engaging portion extends further into the hollow developing roller in the longitudinal direction than the first engaging portion.

6. The developing device according to claim 1, wherein the first engaging portion engages rotatably with the outer surface of the support member.

7. The developing device according to claim 1, further comprising:
a developing frame supporting the developing roller; and
an end member fixed to the developing frame,
wherein the end member includes the support member protruding therefrom.

8. A demountable process cartridge for use with an electrophotographic image forming apparatus, comprising:
an electrophotographic photoreceptor;
a hollow developing roller developing an electrostatic latent image formed on the electrophotographic photoreceptor;
a support member inserted in the developing roller to support the developing roller;
a flange member having a first engaging portion engaging with an outer surface of the support member and a second engaging portion engaging with an inner surface of the developing roller; and
a gap-holding member disposed at one end of the developing roller, the gap-holding member having an abutment abutting against the electrophotographic photoreceptor for maintaining a uniform gap between the developing roller and the electrophotographic photoreceptor,
wherein the abutment overlaps with the second engaging portion in the longitudinal direction of the developing roller.

9. The demountable process cartridge according to claim 8, wherein the abutment overlaps with the first engaging portion in the longitudinal direction of the developing roller.

10. The process cartridge according to claim 8, wherein the abutment lies in the second engaging portion in the longitudinal direction of the developing roller.

11. The process cartridge according to claim 8, further comprising a magnet disposed in the developing roller,
wherein the support member comprises a positioning portion positioning the magnet relative to the developing roller; and a guide guiding the magnet to the positioning portion, and
wherein the guide rotates the magnet as the magnet is being inserted into the support member.

12. The process cartridge according to claim 8, wherein the second engaging portion extends further into the developing roller in the longitudinal direction than the first engaging portion.

13. The process cartridge according to claim 8, wherein the first engaging portion engages rotatably with the outer surface of the support member.

14. The process cartridge according to claim 8, further comprising a developing frame supporting the developing roller; and an end member fixed to the developing frame, wherein the end member includes the support member extending therefrom.

15. An image forming apparatus comprising:
an optical system;
a demountable process cartridge forming an image on a recording medium, including:
an electrophotographic photoreceptor, wherein the optical system emits light onto the photoreceptor to form an electrostatic latent image thereon;
a hollow developing roller developing the electrostatic latent image formed on the electrophotographic photoreceptor;
a support member inserted in the developing roller to support the developing roller;
a flange member having a first engaging portion engaging with an outer surface of the support member and a second engaging portion engaging with an inner surface of the developing roller; and
a gap-holding member disposed at one end of the developing roller, the gap-holding member having an abutment abutting against the electrophotographic photoreceptor for maintaining a gap between the developing roller and the electrophotographic photoreceptor,
wherein the abutment overlaps with the second engaging portion in the longitudinal direction of the developing roller;
fixing means for fixing the image onto the recording medium; and
transporting means for transporting the recording medium to the process cartridge and to the fixing means.

16. The image forming apparatus of claim 15, wherein the abutment overlaps with the first engaging portion in the longitudinal direction of the developing roller.
